(19) United States
(12) Patent Application Publication
(10) Pub. No.: US 2026/0368160 A1
(43) Pub. Date: Nov. 19, 2026

(54) SEARCH APPARATUS, SEARCH METHOD, AND NON-TRANSITORY COMPUTER-READABLE MEDIUM

(71) Applicant: NEC Corporation, Tokyo (JP)

(72) Inventors: Noboru YOSHIDA, Tokyo (JP); Tingting DONG, Tokyo (JP); Kun YI, Tokyo (JP); Jianquan LIU, Tokyo (JP)

(73) Assignee: NEC Corporation, Tokyo (JP)

(21) Appl. No.: 19/138,741

(22) PCT Filed: Dec. 8, 2023
(86) PCT No.: PCT/JP2023/044040

§ 371 Date: Jun. 13, 2025

(30) Foreign Application Priority Data
Dec. 21, 2022 (JP) 2022-204368

(51) Int. Cl. G06F 16/2452

(52) U.S. Cl. CPC G06F 16/2452

(57) ABSTRACT

The present invention provides a search apparatus including:
an input accepting unit that accepts a search query in which an attribute value and a confidence level of the attribute value are set for at least one attribute; a modifying unit that modifies the set search query, based on the attribute value and the confidence level, and generates a modified search query; and a search unit that searches, from among pieces of registered information registered in a database, for the registered information matching the modified search query.

### TECHNICAL FIELD

The present invention relates to a search apparatus, a search method, and a program.

### BACKGROUND ART

Techniques related to the present invention are disclosed in Patent Documents 1 to 5. The techniques disclosed in Patent Documents 1 to 5 search for data matching a search query set by a user.

### Related Document

### Patent Document

Patent Document 1: International Patent Publication No. WO 2022/201541
Patent Document 2: International Patent Publication No. WO 2020/255307
Patent Document 3: Japanese Patent Application Publication No. 2020-198053
Patent Document 4: Japanese Patent Application Publication No. 2018-142160
Patent Document 5: Japanese Patent Application Publication No. 2011-170778

### SUMMARY

### Technical Problem

A user sets a search query specifying an attribute value (feature) of a desired search target, and searches for the desired search target. A search for an image including a desired person, a search for an image captured at a desired location, a search for an image including a desired object, or the like can be cited as one example of a search, but the present invention is not limited to thereto.

In such a search, in a case where a content of a search query is inappropriate, an inconvenience in which a desired search target is not searched for can occur. A “content of a search query is inappropriate” means a state where an attribute value set in the search query is different from an attribute value of the desired search target. For example, a content of a search query can be inappropriate in a case where an attribute value of the desired search target is not clear at a time of a search, and a search query is set based on a vague memory of a user, or in a case where a search query is set based on a content heard from another person. None of Patent Documents 1 to 5 discloses such a challenge or a solution means.

In view of the problem described above, one example of an object of the present invention is to provide a search apparatus, a search method, and a program that solve a challenge of enabling to search for a desired search target with high accuracy.

### Solution to Problem

According to one example aspect of the present invention, there is provided a search apparatus including:
an input accepting unit that accepts a search query in which an attribute value and a confidence level of the attribute value are set for at least one attribute;
a modifying unit that modifies the set search query, based on the attribute value and the confidence level, and generates a modified search query; and
a search unit that searches, from among pieces of registered information registered in a database, for the registered information matching the modified search query.

According to one example aspect of the present invention, there is provided a search method including,
by one or more computers:
   accepting a search query in which an attribute value and a confidence level of the attribute value are set for at least one attribute;
   modifying the set search query, based on the attribute value and the confidence level, and generating a modified search query; and
   searching, from among pieces of registered information registered in a database, for the registered information matching the modified search query.

According to one example aspect of the present invention, there is provided a program causing a computer to function as:
an input accepting unit that accepts a search query in which an attribute value and a confidence level of the attribute value are set for at least one attribute;
a modifying unit that modifies the set search query, based on the attribute value and the confidence level, and generates a modified search query; and
a search unit that searches, from among pieces of registered information registered in a database, for the registered information matching the modified search query.

### Advantageous Effects of Invention

According to one example aspect of the present invention, a search apparatus, a search method, and a program that solve a challenge of enabling to search for a desired search target with high accuracy are achieved.

### BRIEF DESCRIPTION OF THE DRAWINGS

The above-described object, other objects, features, and advantageous effects will become more apparent from a suitable example embodiment described below and the following accompanying drawings.

FIG. 1 It is a diagram illustrating one example of a functional block diagram of a search apparatus.

FIG. 2 It is a diagram illustrating one example of a hardware configuration of a search apparatus.

FIG. 3 It is a diagram schematically illustrating one example of reference information.

FIG. 4 It is a diagram schematically illustrating one example of index information.

FIG. 5 It is a flowchart illustrating one example of a flow of processing of the search apparatus.

FIG. 6 It is a flowchart illustrating another example of the flow of processing of the search apparatus.

FIG. 7 It is a diagram schematically illustrating another example of reference information.

FIG. 8 It is a diagram schematically illustrating another example of reference information.

FIG. 9 It is a diagram schematically illustrating another example of reference information.

FIG. 10 It is a diagram schematically illustrating another example of reference information.

### EXAMPLE EMBODIMENT

Hereinafter, example embodiments of the present invention are described by use of the drawings. Note that, in all of the drawings, a similar component is assigned with a similar reference sign, and description thereof is omitted as appropriate.

### First Example Embodiment

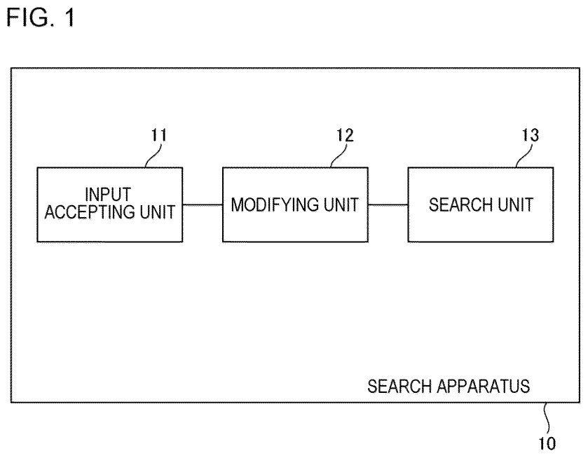

FIG. 1 is a functional block diagram illustrating an outline of a search apparatus 10 according to a first example embodiment. The search apparatus 10 includes an input accepting unit 11, a modifying unit 12, and a search unit 13.

The input accepting unit 11 accepts a search query in which an attribute value and a confidence level of the attribute value are set for at least one attribute. The modifying unit 12 modifies the set search query, based on the attribute value and the confidence level, and generates a modified search query. The search unit 13 searches, from among pieces of registered information registered in a database, for the registered information matching the modified search query.

According to the search apparatus 10 that performs a search by use of a modified search query acquired by modifying a set search query, there is a possibility that a desired search target may be searched for even in a case where a search query with an inappropriate content or a possibility thereof is set. The above search apparatus 10 enables to search for a desired search target with high accuracy.

### Second Example Embodiment

### “Outline”

A search apparatus 10 according to a second example embodiment is a specific form of the search apparatus 10 according to the first example embodiment. Then, the search apparatus 10 according to the second example embodiment includes a unit that modifies a search query by an appropriate method and generates a modified search query.

In such a case that a search query is set based on a vague memory of a user or a search query is set based on a content heard from another person, there is a possibility that an attribute value of a search target is confused within a certain range, and an incorrect search query is set. A range of confusion falls within a certain range, and rarely goes beyond the range. For example, a person in his or her thirties may be confused with a person in his or her twenties, forties, or fifties, but is rarely confused with a person equal to or less than teens or equal to or more than sixties. A unit that modifies a search query set by the user is previously determined based on such a regularity. Then, the search apparatus 10 appropriately modifies, by use of the unit, the search query set by the user, and generates a modified search query. Detailed description is given below.

### “Hardware Configuration”

One example of a hardware configuration of the search apparatus 10 is described. Each functional unit of the search apparatus 10 is achieved by any combination of hardware and software. It is appreciated by a person skilled in the art that there are a variety of modified examples of a method and an apparatus for the achievement. Software includes a program previously stored from a phase of shipping an apparatus, a program downloaded from a medium such as a compact disc (CD) or a server or the like on the Internet, and the like.

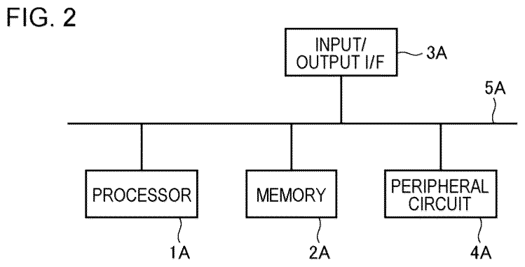

FIG. 2 is a block diagram illustrating a hardware configuration of the search apparatus 10. As illustrated in FIG. 2, the search apparatus 10 includes a processor 1A, a memory 2A, an input/output interface 3A, a peripheral circuit 4A, and a bus 5A. The peripheral circuit 4A includes various modules. The search apparatus 10 may not include the peripheral circuit 4A. Note that, the search apparatus 10 may be configured by a plurality of physically and/or logically separated apparatuses. In this case, each of the plurality of apparatuses can include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. Moreover, the input/output interface 3A includes an interface for connecting to a communication network such as the Internet. The input apparatus is, for example, a keyboard, a mouse, a microphone, a physical button, a touch panel, and the like. The output apparatus is, for example, a display, a speaker, a printer, a mailer, or the like. The processor 1A can give an instruction to each of modules, and perform an arithmetic operation, based on an arithmetic result of each of the modules.

### “Functional Configuration”

Next, a functional configuration of the search apparatus 10 according to the present example embodiment is described in detail. FIG. 1 illustrates one example of a functional block diagram of the search apparatus 10. As illustrated in the figure, the search apparatus 10 includes an input accepting unit 11, a modifying unit 12, and a search unit 13.

The input accepting unit 11 accepts a search query in which an attribute value and a confidence level of the attribute value are set for at least one attribute. One example of the search query is shown below.

(Search query) “Male: 100%, and thirties: 70%, and wearing red pants: 100%”

“Attribute” is an attribute of a search target. A plurality of attributes that can be used for a search for the search target are previously set. A user who sets a search query determines an attribute to be used for the search query within a range of a previously set attribute, and sets an attribute value of the determined attribute. An attribute to be set differs for each search target. A search target is, for example, a person, a location, an object, or the like.

An attribute in a case where a search target is a person is exemplified by a gender, an age, a nationality, a build, height, weight, a hairstyle, a feature of clothing, a feature of a possession, a pose, movement, and the like, but the present invention is not limited to thereto. The attributes may be further subdivided. For example, a feature of clothing may be subdivided in such a way as a feature of a hat, a feature of glasses, a feature of a jacket, a feature of a shoe, or the like.

An attribute in a case where a search target is a location is exemplified by a type of an object present at the location (e.g., a tree, a building, a sign, or the like), a feature of an appearance of the object (e.g., a color, a shape, a size, or the like), and the like, but the present invention is not limited to thereto.

An attribute in a case where a search target is an object is exemplified by a type of the object (e.g., a desk, a chair, a tree, a building, a sign, or the like), a feature of an appearance of the object (e.g., a color, a shape, a size, or the like), and the like, but the present invention is not limited to thereto.

In a case of the example of the search query described above, a search target is a person, and attribute values of three attributes of a gender, an age, and a feature of clothing are set.

The “attribute value” indicates a specific content of the attribute as described above. For example, attribute values of “attribute: gender” are male and female. A plurality of selectable attribute values may be previously set for each attribute. Then, a user who sets a search query may determine an attribute value to be used for a search query within a range of a previously set selectable attribute value. Note that, a method of accepting input of an attribute value illustrated herein is merely one example, and the present invention is not limited to thereto.

In a case of the example of the search query described above, male is set as an attribute value for “attribute: gender”. Moreover, thirties is set as an attribute value for “attribute: age”. Moreover, wearing red pants is set as an attribute value for “attribute: feature of clothing”.

“Confidence level” indicates a level of confidence at which each attribute value set as a search query matches an attribute value of a search target, i.e., is correct. The user sets a confidence level for each attribute value set as a search query. A confidence level is set at, for example, a value between 0 and 100%, but the present invention is not limited to thereto. For example, the user can set a low confidence level for an attribute value of a search target heard from another unreliable person, an attribute value of a search target recalled from a memory from a distant past, or the like. Moreover, for example, the user can set a high confidence level for an attribute value of a search target heard from another reliable person, an attribute value of a search target witnessed recently, or the like.

In a case of the example of the search query described above, a numerical value displayed after each attribute value indicates a confidence level of each attribute value.

A means by which the input accepting unit 11 accepts input of a search query is not particularly limited. For example, the input accepting unit 11 may accept input of a search query via an input apparatus included in the search apparatus 10. Alternatively, the search apparatus 10 may be a server. Then, the input accepting unit 11 may acquire a search query transmitted from a client terminal.

The modifying unit 12 modifies the set search query, based on the attribute value and the confidence level, and generates a modified search query.

As described above, in such a case that a search query is set based on a vague memory of a user or a search query is set based on a content heard from another person, there is a possibility that an attribute value of a search target is confused within a certain range, and an incorrect search query is set. A range of confusion falls within a certain range, and rarely goes beyond the range. For example, a person in his or her thirties may be confused with a person in his or her twenties, forties, or fifties, but is rarely confused with a person equal to or less than teens or equal to or more than sixties. The modifying unit 12 is configured in such a way as to modify a search query set by the user, based on such a regularity.

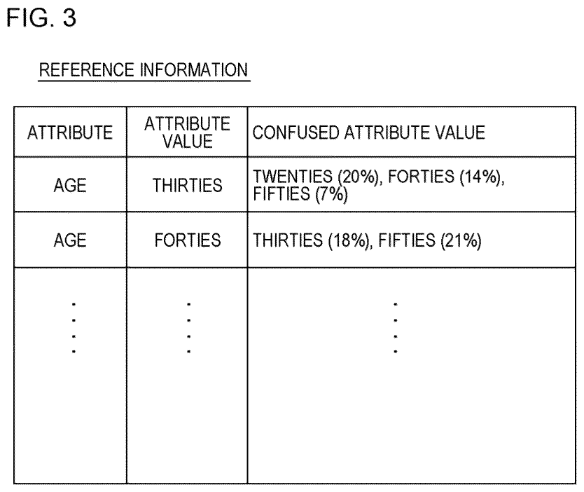

For example, reference information as illustrated in FIG. 3 may be previously generated, and registered in the search apparatus 10. The reference information illustrated in FIG. 3 indicates “another attribute value with a possibility of being confused with each of attribute values set in a search query”, and “a possibility of confusing each of attribute values with each of other attribute values”. One attribute value is determined by values in a column of “attribute” and a column of “attribute value”. Then, a column of “confused attribute value” indicates another attribute value with a possibility of being confused with one attribute value determined by the values in the columns of “attribute” and the “attribute value”. Note that, a numerical value linked with each attribute value indicated in the column of “confused attribute value” indicates a possibility of confusing the one attribute value with each of the other attribute values.

The reference information illustrated in FIG. 3 indicates, in a case where “thirties” is set in the search query, that a person of a search target has a possibility of being actually in his or her twenties, forties, or fifties. Further, the reference information illustrated in FIG. 3 indicates that a person of a search target has a possibility of being actually in his or her twenties (20%), forties (14%), and fifties (7%).

Such reference information can be generated by any means. For example, an administrator (such as a person in charge at a manufacturer) of the search apparatus 10 can ask a plurality of subjects to look at a person of each age group, and answer how old the subjects think the persons are. Then, the administrator of the search apparatus 10 can compile results of the answers, and generate reference information as illustrated in FIG. 3. Note that, the administrator of the search apparatus 10 may change a condition and perform the experiment. For example, a plurality of subjects may be asked to look at a person of each age group without being informed of details, and, after elapse of a certain time since then (e.g., after several days), asked to answer how old the subjects think the persons are. As another example of a way of generation of reference information, the administrator of the search apparatus 10 may generate reference information as illustrated in FIG. 3, based on his or her own experience and sense. Note that, a way of generation of reference information illustrated herein is merely one example, and the present invention is not limited to thereto.

Herein, a specific example of processing of modifying a search query, based on the reference information illustrated in FIG. 3 is described.

The modifying unit 12 can generate a modified search query shown below from a search query shown below, based on, for example, the reference information illustrated in FIG. 3. In a modification below, twenties: 14%, forties: 10%, and fifties: 6% are given to the search query under an AND condition. A feature of the modification processing is described below.

(Search query) “Male: 100%, and thirties: 70%, and wearing red pants: 100%”
(Modified search query) “Male: 100%, and thirties: 70%, and twenties: 14%, and forties: 10%, and fifties: 6%, and wearing red pants: 100%”

### Feature 1

As in the modification example described above, in a case where a search query includes an attribute value (first attribute value) of a certain attribute (first attribute), the modifying unit 12 generates a modified search query including the attribute value (first attribute value) of the attribute (first attribute) and another attribute value (second attribute value) of the attribute (first attribute).

The search query in the modification example described above includes attribute values of three attributes of a gender, an age, and a feature of clothing. The three attributes become the first attributes. Then, male, thirties, and wearing red pants each being the attribute value become the first attribute values.

In the modification example described above, modification is made to the thirties among the three first attribute values. The modifying unit 12 generates a modified search query including thirties (first attribute value), and twenties, forties, and fifties (second attribute values) with other attribute values of the same attribute. The second attribute value is a confused attribute value linked with the first attribute value in the reference information illustrated in FIG. 3. In other words, the second attribute value is an attribute value indicated a possibility of being confused with the first attribute value in the reference information illustrated in FIG. 3.

Note that, the modifying unit 12 can also make a similar modification to the other first attribute values, specifically, male and wearing red pants. However, in the modification example described above, the first attribute values are not targeted for modification. A reason for this becomes clear in Feature 3 below.

### Feature 2

As in the modification example described above, the modifying unit 12 can determine a confidence level of the second attribute value in the modified search query, based on a possibility that each attribute value indicated in the reference information is confused with another attribute value.

There are various computation methods of a confidence level of the second attribute value using a possibility that each attribute value indicated in the reference information is confused with another attribute value. In the modification example described above, the modifying unit 12 allocates a value acquired by subtracting a confidence level of the first attribute value set by the user from 100%, to a plurality of second attribute values according to a possibility that the first attribute value is confused with each of the second attribute values.

Specifically, in the search query of the modification example described above, a confidence level of thirties (first attribute value) is 70%. Thus, the modifying unit 12 allocates 30% being a value acquired by subtracting 70% from 100%, to a plurality of second attribute values (twenties, forties, fifties) according to a possibility of confusing with thirties (twenties: 20%, forties: 14%, fifties: 7%).

In the modification example described above, the confidence level (70%) of the first attribute value set by the user is not modified. As another example, the confidence level (70%) of the first attribute value set by the user may be modified. For example, the reference information illustrated in FIG. 3 indicates a possibility (20%) of confusing thirties with twenties, a possibility (14%) of confusing thirties with forties, and a possibility (7%) of confusing thirties with fifties. From this, a possibility of not confusing thirties with another age can be considered to be 59% (=100%−(20%+14%+7%)). Thus, the modifying unit 12 may use the possibility indicated by the reference information as it is as a confidence level, and generate a modified search query as follows.

(Another example of a modified search query) “Male: 100%, and thirties: 59%, and twenties: 20%, and forties: 14%, and fifties: 7%, and wearing red pants: 100%”

### Feature 3

As in the modification example described above, the modifying unit 12 can target, for modification, an attribute value whose confidence level satisfies a predetermined condition as a target for modification. Then, the modifying unit 12 does not target, for modification, an attribute value whose confidence level does not satisfy a predetermined condition.

The predetermined condition is “confidence level is less than a criterion value”. The criterion value may be 100%, or may be a value less than 100%. In a case where a confidence level is relatively high, the user sets, with confidence, the attribute value for the search query. It is considered that such modification of an attribute value is unnecessary.

In the modification example described above, both male and wearing red pants have a confidence level of 100%, and are equal to or more than the criterion value. Thus, the attribute values are not targeted for modification. Then, another attribute value with a possibility of being confused with the attribute values is not included in the modified search query.

Note that, as a modified example, all attribute values included in the search query may be targeted for modification, regardless of the confidence level.

Returning to FIG. 1, the search unit 13 searches for, from among pieces of registered information registered in a database, registered information matching the modified search query generated by the modifying unit 12. The registered information is an image, but may be text, a sound, or the like.

Search processing by the search unit 13 is specifically described below. Herein, a case where a person is a search target is described by way of example, but search processing is also possible in similar processing in a case where a location, another object, or the like is a search target.

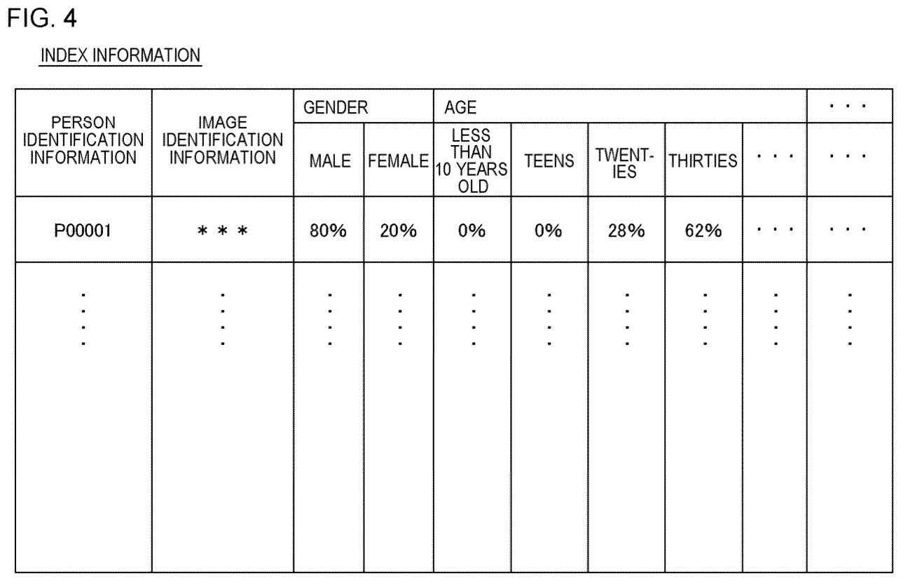

First, index information as illustrated in FIG. 4 is generated by analyzing a plurality of pieces of registered information. Generation timing of the index information is not particularly limited. The index information may be previously generated before timing of a search, or may be generated at a timing of a search.

The index information illustrated in FIG. 4 indicates person identification information, image identification information, an attribute value of each person, and a confidence level thereof.

“Person identification information” is information that identifies each of a plurality of persons detected from an image being registered information.

“Image identification information” is information that identifies an image in which each person is captured. The image identification information may indicate an image file name. Alternatively, the image identification information may indicate a file name of a video file, and information indicating part of the video file (time information such as an elapsed time from beginning).

“Attribute value and confidence level thereof” indicates a confidence level at which each person has each attribute value. Note that, in order to distinguish confidence levels indicated in a search query and a modified search query from a confidence level indicated in index information, the confidence level indicated in the index information is hereinafter referred to as an index confidence level. For example, an attribute value of each person detected from the registered information and an index confidence level thereof are computed by use of a classifier generated by machine learning.

The search unit 13 computes a matching level with the modified search query for each person indicated in the index information. Then, the search unit 13 searches for, as an image matching the modified search query, an image including a person whose matching level satisfies a predetermined matching condition. The matching condition may be “matching level is equal to or more than a threshold value”. Moreover, the matching condition may be “a matching level is included in a top predetermined percentage or a predetermined top number among a plurality of persons indicated in the index information”. Note that, the matching condition exemplified herein is one example, and the present invention is not limited to thereto.

A matching level is computed based on an attribute value indicated in a modified search query, a confidence level, and an index confidence level of the attribute value (an attribute value indicated in the modified search query) indicated in index information. A matching level is higher for a person whose index confidence level of an attribute value indicated in a modified search query is higher.

For example, a matching level M may be computed by a computation equation M=C₁×IC₁+C₂×IC₂+ . . . Cₙ×ICₙ.

n is a serial number of an attribute value included in a modified search query. For example, in a case where the modified search query has the following content, n is a serial number of each of six attribute values of male, thirties, twenties, forties, fifties, and wearing red pants. (Modified search query) “Male: 100%, and thirties: 70%, and twenties: 14%, and forties: 10%, and fifties: 6%, and wearing red pants: 100%”

Cₙ is a confidence level of an n-th attribute value included in the modified search query.

ICₙ is an index confidence level of an “n-th attribute value included in a modified search query” of a person of a processing target (computation target of a matching level) indicated by index information.

Note that, the computation equation described above is merely one example, and the present invention is not limited to thereto. For example, the search unit 13 may compute a statistical value of Cₙ×ICₙ for each attribute, and compute, as the matching level M, a total value acquired by adding up the statistical values for each attribute. The statistical value is an average value, a median value, a mode value, a maximum value, a minimum value, or the like. The modified search query includes three attributes of a gender, an age, and a feature of clothing. Thus, the search unit 13 computes a statistical value of Cₙ×ICₙ in association with each of a gender, an age, and a feature of clothing. Then, the search unit 13 computes, as the matching level M, a total value acquired by adding up the computed three statistical values. In this way, a contribution rate of each of a plurality of attributes to the matching level M can be equalized.

The search unit 13 can output a search result. For example, the search unit 13 can output matching registered information. As one example, the search unit 13 may output the matching registered information via a display or projection apparatus included in the search apparatus 10. Alternatively, in a case where the search apparatus 10 is a server, the search unit 13 can transmit the matching registered information to a client terminal.

In a case where there are a plurality of pieces of matching registered information, the search unit 13 may line up and display the pieces of registered information in order of a matching level. The search unit 13 can output information displaying the matching registered information by use of any display method.

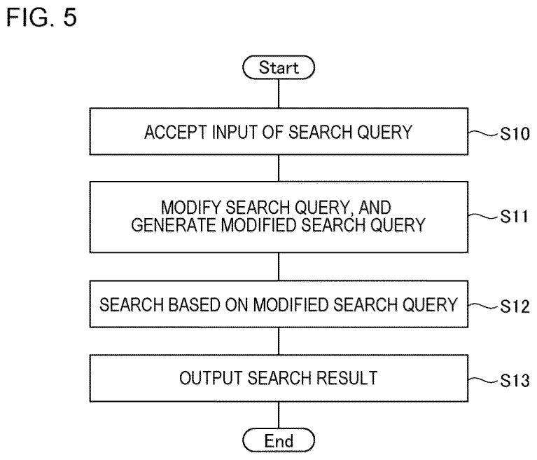

Next, one example of a flow of processing of the search apparatus 10 is described by use of a flowchart in FIG. 5.

First, the search apparatus 10 accepts input of a search query in which an attribute value and a confidence level of the attribute value are set for at least one attribute (S10).

Subsequently, the search apparatus 10 modifies, based on the attribute value and the confidence level indicated by the search query, the search query set in S10, and generates a modified search query (S11).

Subsequently, the search apparatus 10 searches for, from among pieces of registered information registered in a database, registered information matching the modified search query generated in S11 (S12).

Then, the search apparatus 10 outputs a search result indicating the registered information matching the modified search query (S13).

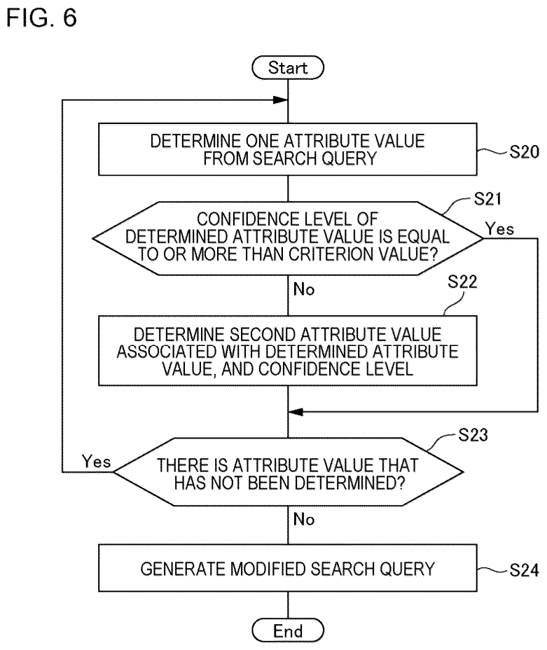

Next, one example of processing of generating a modified search query is described by use of a flowchart in FIG. 6.

First, the search apparatus 10 determines one attribute value from a search query (S20).

Then, the search apparatus 10 assesses whether a confidence level of the determined attribute value is equal to or more than a criterion value (S21).

In a case where the confidence level of the determined attribute value is not equal to or more than the criterion value (No in S21), the search apparatus 10 determines a second attribute value associated with the determined attribute value, and a confidence level (S22). The second attribute value associated with the determined attribute value is an attribute value with a possibility of being confused with the determined attribute value. For example, the second attribute value associated with the determined attribute value is an attribute value linked with the determined attribute value and registered as a confused attribute value in the reference information as illustrated in FIG. 3. Since a way of determination of a confidence level of the second attribute value has been described above, description thereof herein is omitted.

On the other hand, in a case where the confidence level of the determined attribute value is equal to or more than the criterion value (Yes in S21), the search apparatus 10 does not execute the processing in S22.

Thereafter, in a case where there is an attribute value that has not been determined in the search query (Yes in S23), the processing returns to S20, and similar processing is repeated.

In a case where all attribute values in the search query have been determined (No in S23), the search apparatus 10 generates a modified search query, based on the search query and a determined content in S22 (S24). Specifically, the search apparatus 10 generates a modified search query by giving the second attribute value and the confidence level thereof determined in S22 to the search query. The second attribute value and the confidence level thereof determined in S22 are given to the search query under, for example, an AND condition, but the present invention is not limited to thereto.

“advantageous Effect”

The search apparatus 10 according to the second example embodiment achieves an advantageous effect similar to that of the search apparatus 10 according to the first example embodiment.

Moreover, in such a case that a search query is set based on a vague memory of a user or a search query is set based on a content heard from another person, there is a possibility that an attribute value of a search target is confused within a certain range, and an incorrect search query is set. The search apparatus 10 according to the second example embodiment generates a modified search query by adding, to a search query, an attribute value with a possibility of being confused with an attribute values set in the search query. With the above search apparatus 10 according to the second example embodiment, a correct attribute value is included in the modified search query even in a case where an incorrect search query is set due to confusion, and, therefore, there is a possibility that a desired search target is searched for.

Moreover, the search apparatus 10 according to the second example embodiment can determine a confidence level of another attribute value in a modified search query, based on a possibility that each of attribute values set in a search query is confused with each of other attribute values. The above search apparatus 10 according to the second example embodiment can appropriately set a confidence level of another attribute value in the modified search query. As a result, accuracy of a search is improved.

Moreover, the search apparatus 10 according to the second example embodiment can target, for modification, an attribute value whose confidence level is less than a criterion value, and exclude, from a target for modification, an attribute value whose confidence level is equal to or more than the criterion value. Unnecessarily modifying an attribute value that a user has set with confidence increases a processing burden on a computer unnecessarily. The inconvenience can be reduced by targeting, for modification, an attribute value whose confidence level is less than the criterion value, and excluding, from a target for modification, an attribute value whose confidence level is equal to or more than the criterion value.

### Third Example Embodiment

A search apparatus 10 according to a third example embodiment causes a way of modification of an attribute value set in a search query to differ according to a confidence level of each attribute value set in the search query. In a case where the confidence level is high, a possibility that confusion has occurred is low, but in a case where a confidence level is low, a possibility that confusion has occurred is considered to be high. In consideration of such a point, the search apparatus 10 according to the third example embodiment causes a way of modification of an attribute value set in a search query to differ according to a confidence level of the attribute value set in the search query. Detailed description is given below.

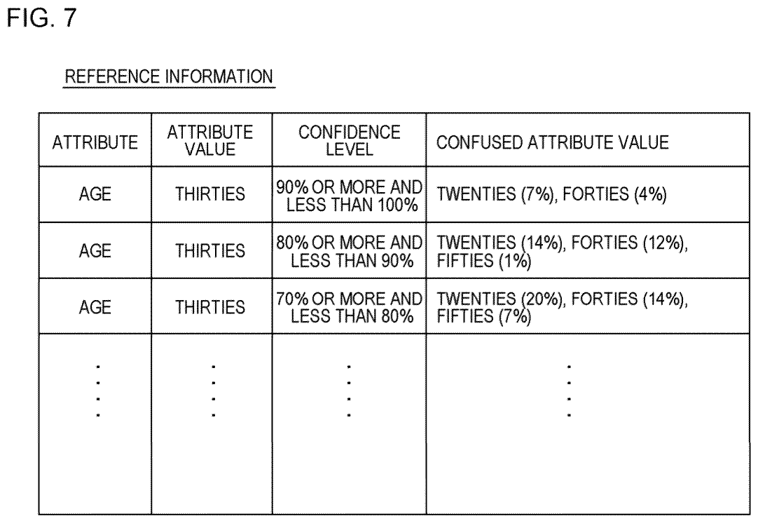

The modifying unit 12 can generate a modified search query from a search query, based on reference information as illustrated in FIG. 7.

The reference information illustrated in FIG. 7 indicates “another attribute value with a possibility of being confused with each attribute value” and “a possibility of confusing each of attribute values with each of other attribute values” in a case where a confidence level set in a search query is within a predetermined range. One attribute value is determined by values in a column of “attribute” and a column of “attribute value”. A column of “confidence level” indicates a confidence level of the determined one attribute value. Then, a column of “confused attribute value” indicates another attribute value with a possibility of being confused with the one attribute value determined by the values in the columns of “attribute” and “attribute value” in a case where a confidence level is within a range indicated by a value in the column of “confidence level”. Note that, a numerical value linked with each attribute value indicated in the column of “confused attribute value” indicates a possibility of confusing each of attribute values with each of other attribute values.

The reference information illustrated in FIG. 7 indicates that, in a case where a search query is set to “thirties” and a confidence level of “90% or more and less than 100%”, a person of a search target has a possibility of being actually in his or her twenties and forties. Further, the reference information illustrated in FIG. 7 indicates a possibility that a person of a search target is actually in his or her twenties (7%), and forties (4%).

Moreover, the reference information illustrated in FIG. 7 indicates that, in a case where a search query is set to “thirties” and a confidence level of “80% or more but less than 90%”, a person of a search target has a possibility of being actually in his or her twenties, forties, or fifties. Further, the reference information illustrated in FIG. 7 indicates a possibility that a person of a search target is actually in his or her twenties (14%), forties (12%), and fifties (1%).

Such reference information can be generated by any means. For example, an administrator (a person in charge at a manufacturer) of the search apparatus 10 asks a plurality of subjects to look at a person of each age group, and answer how old the subjects think the persons are, and a confidence level thereof. Then, the administrator of the search apparatus 10 can compile a result of the answer, and generate reference information as illustrated in FIG. 7. Note that, the administrator of the search apparatus 10 may change a condition and perform the experiment. For example, a plurality of subjects may be asked to look at a person of each age group without being informed of details, and, after elapse of a certain time since then (e.g., after several days), asked to answer how old the subjects think the persons are, and a confidence level thereof. As another example of a way of generation of reference information, the administrator of the search apparatus 10 may generate reference information as illustrated in FIG. 7, based on his or her own experience and sense. Note that, the way of generation of reference information illustrated herein is merely one example, and the present invention is not limited to thereto.

Herein, a specific example of processing of modifying a search query, based on the reference information illustrated in FIG. 7 is described.

The modifying unit 12 can generate a modified search query shown below from a search query shown below, based on, for example, the reference information illustrated in FIG. 7. In a modification below, twenties: 14%, forties: 10%, and fifties: 6% are given to the search query under an AND condition.

(Search query) “Male: 100%, and thirties: 70%, and wearing red pants: 100%”
(Modified search query) “Male: 100%, and thirties: 70%, and twenties: 14%, and forties: 10%, and fifties: 6%, and wearing red pants: 100%”

In a case where the thirties included in the search query are targeted for modification, the modifying unit 12 generates a modified search query, based on a confused attribute value linked with an attribute value: thirties and a confidence level of 70% or more and less than 80%, in the reference information illustrated in FIG. 7. A specific generation method of a modified search query is similar to that according to the second example embodiment.

As described above, the modifying unit 12 determines another attribute value (second attribute value) to be included in the modified search query, and a confidence level thereof, based on the reference information as illustrated in FIG. 7, and the attribute value and confidence level set in the search query. The reference information illustrated in FIG. 7 indicates, in a case where a confidence level of an attribute value set in a search query satisfies a predetermined condition, another attribute value with a possibility of being confused with the attribute value, and a possibility thereof.

A rest of a configuration of the search apparatus 10 according to the third example embodiment is similar to the configuration of the search apparatus 10 according to each of the first and second example embodiments.

The search apparatus 10 according to the third example embodiment achieves an advantageous effect similar to that of the search apparatus 10 according to each of the first and second example embodiments. Moreover, the search apparatus 10 according to the third example embodiment can cause a way of modification of an attribute value set in a search query to differ according to a confidence level of each attribute value set in the search query. In a case where the confidence level is high, a possibility that confusion has occurred is low, but in a case where a confidence level is low, a possibility that confusion has occurred is considered to be high. Accuracy of a search is improved by appropriately modifying each attribute value set in a search query and generating a modified search query in consideration of such a point.

### Fourth Example Embodiment

The search apparatus 10 according to the fourth example embodiment causes a way of modification of an attribute value set in a search query to differ according to an attribute of “an eyewitness who has witnessed a search target and presented an attribute value to be included in a search query”.

Presence or absence of confusion and a way of confusion can differ according to an attribute of an eyewitness. For example, in a case where an eyewitness is a child, a possibility of confusing an age of a search target between twenties and forties becomes high in comparison with a case where an eyewitness is an adult. Moreover, an eyewitness of a nationality different from a search target has a higher possibility of confusing an age of a search target, in comparison with an eyewitness of the same nationality as the search target. Moreover, an eyewitness of a gender different from a search target has a higher possibility of confusing a feature of clothing or a possession of the search target, in comparison with an eyewitness of the same gender as the search target. Moreover, an eyewitness with a fashion preference different from a search target has a possibility of confusing a feature of clothing or a possession of the search target, in comparison with an eyewitness with the same fashion preference as the search target.

In consideration of such a point, the search apparatus 10 according to the fourth example embodiment causes a way of modification of an attribute value set in a search query to differ according to an attribute of “an eyewitness who has witnessed a search target and presented an attribute value to be included in a search query”. Detailed description is given below.

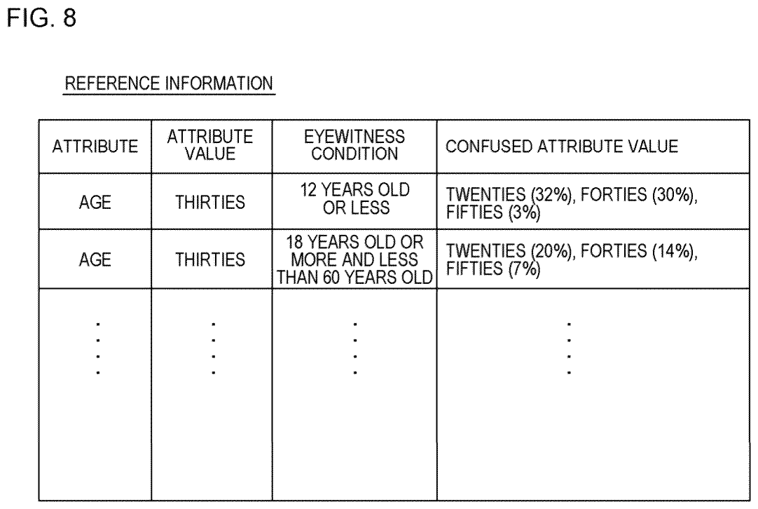

A modifying unit 12 can generate a modified search query from a search query, based on reference information as illustrated in FIG. 8.

The reference information illustrated in FIG. 8 indicates “another attribute value with a possibility of being confused with each of attribute values set based on an eyewitness testimony of an eyewitness satisfying a predetermined witness condition” and “a possibility of confusing each of attribute values with each of other attribute values”. One attribute value is determined by values in a column of “attribute” and a column of “attribute value”.

A column of “eyewitness condition” indicates a condition of an eyewitness. A condition of an eyewitness is defined by use of a gender, an age, a nationality, a hairstyle, a feature of clothing, a feature of a possession, or the like.

Then, in a case where an eyewitness satisfying a predetermined eyewitness condition, a column of “confused attribute value” indicates another attribute value with a possibility of being confused with one attribute value determined by values in the columns of “attribute” and “attribute value”. Note that, a numerical value linked with each attribute value indicated in the column of “confused attribute value” indicates a possibility of confusing.

The reference information illustrated in FIG. 8 indicates that, in a case where an eyewitness is “12 years old or less” and a search query is set to “thirties”, a person of a search target has a possibility of being actually in his or her twenties, forties, or fifties. Further, the reference information illustrated in FIG. 8 indicates a possibility that a person of a search target is actually in his or her twenties (32%), forties (30%), and fifties (3%).

Moreover, the reference information illustrated in FIG. 8 indicates that, in a case where an eyewitness is “18 years old or more and less than 60 years old” and a search query is set to “thirties”, a person of a search target has a possibility of being actually in his or her twenties, forties, or fifties. Further, the reference information illustrated in FIG. 8 indicates a possibility that a person of a search target is actually in his or her twenties (20%), forties (14%), and fifties (7%).

Such reference information can be generated by any means. For example, an administrator (a person in charge at a manufacturer) of the search apparatus 10 asks a plurality of subjects to look at a person of each age group, and answer how old the subjects think the persons are. Then, the administrator of the search apparatus 10 may compile a result of the answer separately for each attribute of an eyewitness, and generate reference information as illustrated in FIG. 8. Note that, the administrator of the search apparatus 10 may change a condition and perform the experiment. For example, a plurality of subjects may be asked to look at a person of each age group without being informed of details, and, after elapse of a certain time since then (e.g., after several days), asked to answer how old the subjects think the persons are. As another example of a way of generation of reference information, the administrator of the search apparatus 10 may generate reference information as illustrated in FIG. 8, based on his or her own experience and sense. Note that, the way of generation of reference information illustrated herein is merely one example, and the present invention is not limited to thereto.

Herein, a specific example of processing of modifying a search query, based on the reference information illustrated in FIG. 8 is described.

First, the input accepting unit 11 accepts an input of setting an attribute of an eyewitness, in addition to a search query. In other words, the user inputs the attribute of the eyewitness to the search apparatus 10.

The modifying unit 12 can generate a modified search query shown below from a search query shown below, based on, for example, the reference information illustrated in FIG. 8. In a modification below, twenties: 14%, forties: 10%, and fifties: 6% are given to the search query under an AND condition.

(Search query) “Male: 100%, and thirties: 70%, and wearing red pants: 100%”
(Modified search query) “Male: 100%, and thirties: 70%, and twenties: 14%, and forties: 10%, and fifties: 6%, and wearing red pants: 100%”

For example, it is assumed that an input attribute of an eyewitness is 40 years old. Then, in a case where the thirties included in the search query is targeted for modification, the modifying unit 12 generates a modified search query, based on a confused attribute value linked with an attribute value: thirties, and an eyewitness condition: 18 years old or more and less than 60 years old in the reference information illustrated in FIG. 8. A specific generation method of the modified search query is similar to that according to the second example embodiment.

As described above, the modifying unit 12 determines another attribute value (second attribute values) to be included in a modified search query, and a confidence level thereof, based on a set attribute of an eyewitness, the reference information as illustrated in FIG. 8, and an attribute value and a confidence level set in a search query. The reference information illustrated in FIG. 8 indicates another attribute value with a possibility of being confused with each of attribute values in a case where an attribute of an eyewitness satisfies a predetermined eyewitness condition, and a possibility thereof.

A rest of a configuration of the search apparatus 10 according to the fourth example embodiment is similar to the configuration of the search apparatus 10 according to each of the first to third example embodiments.

The search apparatus 10 according to the fourth example embodiment achieves an advantageous effect similar to that of the search apparatus 10 according to each of the first to third example embodiments. Moreover, the search apparatus 10 according to the fourth example embodiment can cause a way of modification of an attribute value set in a search query to differ according to an attribute of “an eyewitness who has witnessed a search target and presented an attribute value to be included in a search query”.

Presence or absence of confusion and a way of confusion can differ according to an attribute of an eyewitness. For example, in a case where an eyewitness is a child, a possibility of confusing an age of a search target between twenties and forties becomes high in comparison with a case where an eyewitness is an adult. Moreover, an eyewitness of a nationality different from a search target has a higher possibility of confusing an age of a search target, in comparison with an eyewitness of the same nationality as the search target. Moreover, an eyewitness of a gender different from a search target has a higher possibility of confusing a feature of clothing or a possession of the search target, in comparison with an eyewitness of the same gender as the search target. Moreover, an eyewitness with a fashion preference different from a search target has a higher possibility of confusing a feature of clothing or a possession of the search target, in comparison with an eyewitness with the same fashion preference as the search target.

Accuracy of a search is improved by appropriately modifying each attribute value set in a search query and generating a modified search query in consideration of such a point.

### Fifth Example Embodiment

A search apparatus 10 according to the fifth example embodiment causes a way of modification of an attribute value set in a search query to differ according to an environment in a case where a search target is witnessed.

Presence or absence of confusion and a way of confusion can differ according to an environment during witnessing. For example, how a target looks and how a color looks can differ according to timing such as night, evening, daytime, or morning. Moreover, how a target looks and how a color looks can differ according to weather such as fair, rainy, or cloudy.

Moreover, how a target looks and how a color looks can differ according to whether it is outdoors or indoors. Moreover, in a case where there are many persons around, a possibility of confusing an attribute of a target can be high, but, in a case where there are few or no persons around, a possibility of confusing an attribute of a target can be low.

In consideration of such a point, the search apparatus 10 according to the fifth example embodiment causes a way of modification of an attribute value set in a search query to differ according to an environment in a case where a search target is witnessed. Detailed description is given below.

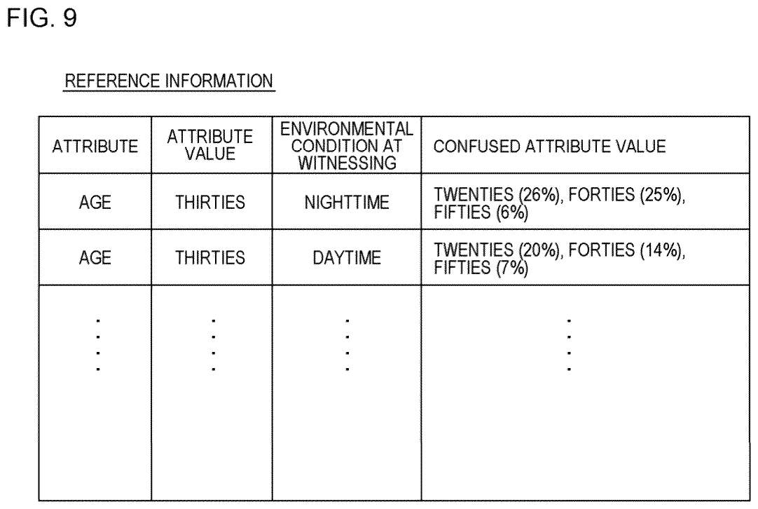

A modifying unit 12 can generate a modified search query from a search query, based on reference information as illustrated in FIG. 9.

The reference information illustrated in FIG. 9 indicates “another attribute value with a possibility of being confused with each of attribute values set based on witnessing in an environment satisfying a predetermined environmental condition at witnessing” and “a possibility of confusing each of attribute values with each of other attribute values”. One attribute value is determined by values in a column of “attribute” and a column of “attribute value”.

A column of “environmental condition at witnessing” indicates a condition of an environment at witnessing. A condition of an environment at witnessing is defined by use of a time period, daytime or nighttime, weather, indoors or outdoors, whether there are many persons around, and the like.

Then, in a case of an environment satisfying a predetermined environmental condition at witnessing, a column of “confused attribute value” indicates another attribute value with a possibility of being confused with one attribute value determined by the values in the columns of “attribute” and “attribute value”. Note that, a numerical value linked with each attribute value indicated in the column of “confused attribute value” indicates a possibility of confusing.

The reference information illustrated in FIG. 9 indicates that, in a case where an environment at witnessing is “nighttime” and a search query is set to “thirties”, a person of a search target has a possibility of being actually in his or her twenties, forties, or fifties. Further, the reference information illustrated in FIG. 9 indicates a possibility that a person of a search target is actually in his or her twenties (26%), forties (25%), and fifties (6%).

Moreover, the reference information illustrated in FIG. 9 indicates that, in a case where an environment at witnessing is “daytime” and a search query is set to “thirties”, a person of a search target has a possibility of being actually in his or her twenties, forties, or fifties. Further, the reference information illustrated in FIG. 9 indicates a possibility that a person of a search target is actually in his or her twenties (20%), forties (14%), and fifties (7%).

Such reference information can be generated by any means. For example, an administrator (a person in charge at a manufacturer) of the search apparatus 10 asks a plurality of subjects to look at a person of each age group in a predetermined environment, and answer how old the subjects think the persons are. Then, the administrator of the search apparatus 10 can compile a result of the answer separately for each environment, and generate reference information as illustrated in FIG. 9. Note that, the administrator of the search apparatus 10 may change a condition and perform the experiment. For example, a plurality of subjects may be asked to look at a person of each age group in a predetermined environment without being informed of details, and, after elapse of a certain time since then (e.g., after several days), asked to answer how old the subjects think the persons are. As another example of a way of generation of reference information, the administrator of the search apparatus 10 may generate reference information as illustrated in FIG. 9, based on his or her own experience and sense. Note that, the way of generation of reference information illustrated herein is merely one example, and the present invention is not limited to thereto.

Herein, a specific example of processing of modifying a search query, based on the reference information illustrated in FIG. 9 is described.

First, an input accepting unit 11 accepts an input of setting an environment at witnessing, in addition to a search query. In other words, a user inputs the environment at witnessing to the search apparatus 10.

The modifying unit 12 can generate a modified search query shown below from a search query shown below, based on, for example, the reference information illustrated in FIG. 9. In a modification below, twenties: 14%, forties: 10%, and fifties: 6% are given to the search query under an AND condition.

(Search query) “Male: 100%, and thirties: 70%, and wearing red pants: 100%”
(Modified search query) “Male: 100%, and thirties: 70%, and twenties: 14%, and forties: 10%, and fifties: 6%, and wearing red pants: 100%”

For example, it is assumed that an input environment at witnessing is daytime. In a case where the thirties included in the search query is targeted for modification, the modifying unit 12 generates a modified search query, based on a confused attribute value linked with an attribute value: thirties, and an environmental condition at witnessing: daytime in the reference information illustrated in FIG. 9. A specific generation method of the modified search query is similar to that according to the second example embodiment.

As described above, the modifying unit 12 determines another attribute value (second attribute value) to be included in a modified search query, and a confidence level thereof, based on a set environment at witnessing, the reference information as illustrated in FIG. 9, and an attribute value and a confidence level set in a search query. The reference information illustrated in FIG. 9 indicates another attribute value with a possibility of being confused with each of attribute values in a case where an environment at witnessing satisfies a predetermined environmental condition at witnessing, and a possibility thereof.

A rest of a configuration of the search apparatus 10 according to the fifth example embodiment is similar to the configuration of the search apparatus 10 according to each of the first to fourth example embodiments.

The search apparatus 10 according to the fifth example embodiment achieves an advantageous effect similar to that of the search apparatus 10 according to each of the first to fourth example embodiments. Moreover, the search apparatus 10 according to the fifth example embodiment can cause a way of modification of an attribute value set in a search query to differ according to an environment in a case where a search target is witnessed.

Presence or absence of confusion and a way of confusion can differ according to an environment at witnessing. For example, how a target looks and how a color looks can differ according to timing such as night, evening, daytime, or morning. Moreover, how a target looks and how a color looks can differ according to weather such as fair, rainy, or cloudy. Moreover, how a target looks and how a color looks can differ according to whether it is outdoors or indoors. Moreover, in a case where there are many persons around, a possibility of confusing an attribute of a target can be high, but, in a case where there are few or no persons around, a possibility of confusing an attribute of a target can be low.

Accuracy of a search is improved by appropriately modifying each attribute value set in a search query and generating a modified search query in consideration of such a point.

The search apparatus 10 according to the sixth example embodiment causes a way of modification of an attribute value set in a search query to differ according to another attribute value set in the search query.

As one example, a feature of clothing set in a search query can be utilized in a modification of an age of a search target. For example, in a case where “wearing a miniskirt” is set in the search query, an age of a person of a search target is narrowed down to a certain extent according to the feature. Moreover, it is preferable to cause a way of narrowing down to differ in whether a confidence level of the attribute value is set to be high in the search query.

In consideration of such a point, the search apparatus 10 according to the sixth example embodiment causes a way of modification of an attribute value set in a search query to differ according to another attribute value set in the search query. Detailed description is given below. Note that, in order to distinguish between the “another attribute value” set in a search query and “another attribute value” with a possibility of being confused with each attribute value, “another attribute value” set in the search query is hereinafter referred to as a “simultaneously set attribute value”.

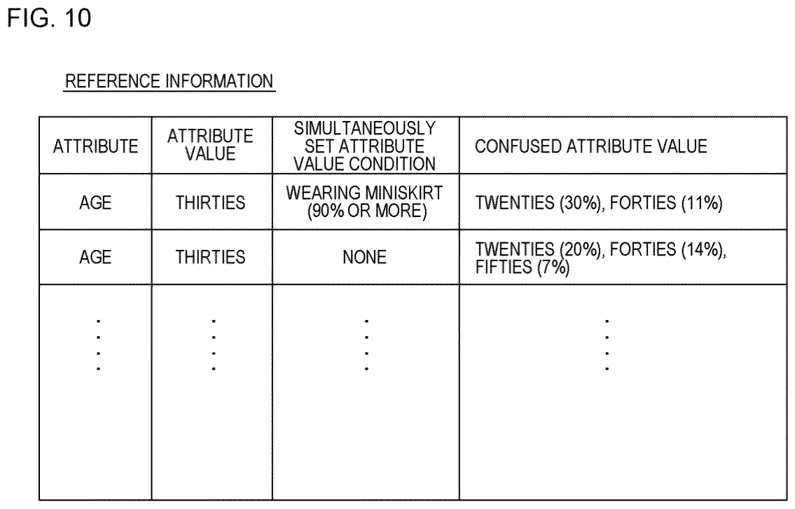

The modifying unit 12 can generate a modified search query from the search query, based on reference information as illustrated in FIG. 10.

The reference information illustrated in FIG. 10 indicates “another attribute value with a possibility of being confused with each attribute value” and “a possibility of confusing each of attribute values with each of other attribute values”, in a case where a simultaneously set attribute value set together with each attribute value satisfies a predetermined simultaneously set attribute value condition in a search query. One attribute value is determined by values in a column of “attribute” and a column of “attribute value”.

A column of “simultaneously set attribute value condition” indicates a condition relating to a simultaneously set attribute value set in a search query. The simultaneously set attribute value condition is defined by a content such as what attribute value is included in the search query, and what attribute value is included in the search query with what confidence level. Alternatively, the simultaneously set attribute value condition may be defined by a content such as what attribute value is not included in the search query.

Then, in a case of satisfying a predetermined simultaneously set attribute value condition, the column of “confused attribute value” indicates another attribute value with a possibility of being confused with one attribute value determined by values in the columns of “attribute” and “attribute value”. Note that, a numerical value linked with each attribute value indicated in the column of “confused attribute value” indicates a possibility of confusing.

The reference information illustrated in FIG. 10 indicates that, in a case where a search query is set to “thirties” and further set to “wearing a miniskirt” with a confidence level of 90% or more, a person of a search target has a possibility of being actually in his or her twenties and forties. Further, the reference information illustrated in FIG. 10 indicates a possibility that a person of a search target is actually in his or her twenties (30%) and forties (11%).

Moreover, the reference information illustrated in FIG. 10 indicates that, in a case where a search query is set to “thirties” and not set to “wearing a miniskirt” with a confidence level of 90% or more, a person of a search target has a possibility of being actually in his or her twenties, forties, or fifties. Further, the reference information illustrated in FIG. 10 indicates a possibility that a person of a search target is actually in his or her twenties (20%), forties (14%), and fifties (7%).

Such reference information can be generated by any means. For example, an administrator (a person in charge at a manufacturer) of the search apparatus 10 asks a plurality of subjects to look at a person of each age group, and answer how old the subjects think the persons are. Then, the administrator of the search apparatus 10 compiles a result of the answer. Moreover, the administrator (such as a person in charge at a manufacturer) of the search apparatus 10 compiles a tendency of attribute values of a plurality of randomly chosen subjects, and compute a tendency. Thereby, a possibility that a person with each attribute value (e.g., twenties, thirties, forties, and the like) has a predetermined attribute value (e.g., wearing a miniskirt) can be computed. The administrator of the search apparatus 10 can integrate results of the compilation described above by any method, and generate reference information as illustrated in FIG. 10. Note that, the administrator of the search apparatus 10 may change a condition and perform the experiment. For example, a plurality of subjects may be asked to look at a person of each age group without being informed of details, and, after elapse of a certain time since then (e.g., after several days), asked to answer how old the subjects think the persons are. As another example of a way of generation of reference information, the administrator of the search apparatus 10 may generate reference information as illustrated in FIG. 10, based on his or her own experience and sense. Note that, the way of generation of reference information illustrated herein is merely one example, and the present invention is not limited to thereto.

Herein, a specific example of processing of modifying a search query, based on the reference information illustrated in FIG. 10 is described.

The modifying unit 12 refers to the reference information illustrated in FIG. 10, and determines which “simultaneously set attribute value condition” an attribute value of a modification target satisfies. Then, the modifying unit 12 generates a modified search query, based on a confused attribute value linked with the determined simultaneously set attribute value condition. A specific generation method of a modified search query is similar to that according to the second example embodiment.

As described above, the modifying unit 12 determines another attribute value (second attribute value) to be included in a modified search query and a confidence level thereof, based on reference information as illustrated in FIG. 10. The reference information illustrated in FIG. 10 indicates another attribute value with a possibility of being confused with each of attribute values in a case where another attribute value set in a search query satisfies a predetermined simultaneously set attribute value condition, and a possibility thereof.

A rest of a configuration of the search apparatus 10 according to the sixth example embodiment is similar to the configuration of the search apparatus 10 according to each of the first to fifth example embodiments.

The search apparatus 10 according to the sixth example embodiment achieves an advantageous effect similar to that of the search apparatus 10 according to each of the first to fifth example embodiments. Moreover, the search apparatus 10 according to the sixth example embodiment can cause a way of modification of an attribute value set in a search query to differ according to another attribute value set in a search query.

As one example, a feature of clothing set in a search query can be utilized in a modification of an age of a search target. For example, in a case where “wearing a miniskirt” is set in the search query, an age of a person of a search target is narrowed down to a certain extent according to the feature. Moreover, it is preferable to cause a way of narrowing down to differ in whether a confidence level of the attribute value is set to be high in the search query.

Accuracy of a search is improved by appropriately modifying each attribute value set in a search query and generating a modified search query in consideration of such a point.

### Seventh Example Embodiment

A search apparatus 10 according to a seventh example embodiment causes a way of modification of an attribute value set in a search query to differ according to an elapsed time since a timing of witnessing a search target.

Presence or absence of confusion and a way of confusion can differ according to an elapsed time since a timing of witnessing a search target. Generally, as the elapsed time becomes larger, it becomes easier for confusion to occur. Moreover, as the elapsed time becomes larger, a range of confusion becomes larger.

In consideration of such a point, the search apparatus 10 according to the seventh example embodiment causes a way of modification of an attribute value set in a search query to differ according to an elapsed time since a timing of witnessing a search target. Detailed description is given below.

A modifying unit 12 modifies a search query, based on a confused attribute value of a plurality of patterns according to an elapsed time since a timing of witnessing a search target, and reference information specifying a possibility of confusion, and generates a modified search query. A way of modification is similar to that according to the example embodiment described above. A user inputs an elapsed time since a timing of witnessing a search target to the search apparatus 10.

Such reference information can be generated by any means. For example, an administrator (a person in charge at a manufacturer) of the search apparatus 10 asks a plurality of subjects to look at a person of each age group in a predetermined environment, and, after elapse of a predetermined time since then, answer how old the subjects think the person is. The elapsed time is caused to differ for each subject. Then, the administrator of the search apparatus 10 can compile a result of the answer separately for each elapsed time, and generate reference information as described above. As another example of a way of generation of reference information, the administrator of the search apparatus 10 may generate reference information as described above, based on his or her own experience and sense. Note that, the way of generation of reference information illustrated herein is merely one example, and the present invention is not limited to thereto.

A rest of a configuration of the search apparatus 10 according to the seventh example embodiment is similar to the configuration of the search apparatus 10 according to each of the first to sixth example embodiments.

The search apparatus 10 according to the seventh example embodiment achieves an advantageous effect similar to that of the search apparatus 10 according to each of the first to sixth example embodiments. Moreover, the search apparatus 10 according to the seventh example embodiment can cause a way of modification of an attribute value set in a search query to differ according to an elapsed time since a timing of witnessing a search target.

Presence or absence of confusion and a way of confusion can differ according to an elapsed time since a timing of witnessing a search target. Generally, as the elapsed time becomes larger, it becomes easier for confusion to occur. Moreover, as the elapsed time becomes larger, a range of confusion becomes larger.

Accuracy of a search is improved by appropriately modifying each attribute value set in a search query and generating a modified search query in consideration of such a point.

### Eighth Example Embodiment

A search apparatus 10 according to an eighth example embodiment generates a modified search query from a search query by a method combining a plurality of methods described in the third to seventh example embodiments.

In other words, the search apparatus 10 according to the eighth example embodiment cause a way of modification of an attribute value set in a search query to differ according to at least two of “a confidence level of each attribute value set in the search query”, “an attribute of an eyewitness who has witnessed a search target and presented an attribute value to be included in a search query”, “an environment in a case where a search target is witnessed”, “another attribute value set in a search query”, and “an elapsed time since a timing of witnessing a search target”.

Specifically, in a case where a predetermined condition defined by use of at least two of a plurality of items described above is satisfied, reference information indicates another attribute value with a possibility of being confused with each attribute, and a possibility of the confusion. Then, the modifying unit 12 generates a modified search query from a search query by use of the reference information.

A rest of a configuration of the search apparatus 10 according to the eighth example embodiment is similar to the configuration of the search apparatus 10 according to each of the first to seventh example embodiments. The search apparatus 10 according to the eighth example embodiment achieves an advantageous effect similar to that of the search apparatus 10 according to each of the first to seventh example embodiments. Moreover, a possibility that each attribute value is confused with another attribute value can be defined by more finely performing case classification. As a result, a search query can be more appropriately modified, and a modified search query can be generated.

### Ninth Example Embodiment

A search apparatus 10 according to a ninth example embodiment generates a modified search query from a search query by use of a learning model that has learned a tendency of confusion as described in the above example embodiments.

In other words, a modifying unit 12 generates a modified search query from a search query by use of a learning model that has learned a tendency of confusion as described in the example embodiment described above.

For example, according to input of an attribute value, the learning model outputs a confused attribute value with a possibility of being confused with that attribute value, and a probability thereof.

Alternatively, according to an attribute value, and input of a confidence level of the attribute value, a learning model may output a confused attribute value with a possibility of being confused with the attribute value, and a possibility thereof. The learning model is acquired by learning a tendency of confusion described in the third example embodiment.

Alternatively, according to an attribute value, and input of an attribute of an eyewitness, a learning model may output a confused attribute value with a possibility of being confused with the attribute value, and a possibility thereof. The learning model is acquired by learning a tendency of confusion described in the fourth example embodiment.

Alternatively, according to an attribute value, and input of an environment at witnessing, a learning model may output a confused attribute value with a possibility of being confused with the attribute value, and a possibility thereof. The learning model is acquired by learning a tendency of confusion described in the fifth example embodiment.

Alternatively, according to an attribute value, and input of another attribute value set in a search query, a learning model may output a confused attribute value with a possibility of being confused with the attribute value, and a possibility thereof. The learning model is acquired by learning a tendency of confusion described in the sixth example embodiment.

Alternatively, according to an attribute value, and input of an elapsed time since a timing of witnessing a search target, a learning model may output a confused attribute value with a possibility of being confused with the attribute value, and a possibility thereof. The learning model is acquired by learning a tendency of confusion described in the seventh example embodiment.

Alternatively, according to input of an “attribute value” and “at least two of a confidence level of the attribute value, an attribute of an eyewitness, an environment at witnessing and another attribute value set in a search query, and an elapsed time since a timing of witnessing a search target”, a learning model may output a confused attribute value with a possibility of being confused with the attribute value, and a possibility thereof. The learning model is acquired by learning a tendency of confusion described in the eighth example embodiment.

A rest of a configuration of the search apparatus 10 according to the ninth example embodiment is similar to the configuration of the search apparatus 10 according to each of the first to eighth example embodiments. The search apparatus 10 according to the ninth example embodiment achieves an advantageous effect similar to that of the search apparatus 10 according to each of the first to eighth example embodiments.

### Modified Examples

Hereinafter, modified examples applicable to all of the example embodiments described above are described. The modified examples also achieve an advantageous effect similar to that according to each of the example embodiments described above.

### “First Modified Example”

(Search query) “thirties: 20% and forties: 70%”

As in the example described above, in a search query, a plurality of attribute values may be set in association with one attribute. In the example described above, two attribute values of thirties and forties are set in association with age.

In such a case, a modifying unit 12 generates a modified search query, based on the plurality of attribute values. Specifically, the modifying unit 12 determines, based on the plurality of attribute values, “attribute value associated with the attribute” to be included in the modified search query, and a “confidence level thereof”. In a case of the example described above, the modifying unit 12 determines, based on two attribute values of thirties and forties, an attribute value of an age to be included in the modified search query, and a confidence level thereof.

There are various methods of modification. A case where the search query in the example described above is modified based on reference information in FIG. 3 is described below as an example.

### Example 1

As one example, the modifying unit 12 may include, in a modified search query, all of other attribute values with a possibility of being confused with each of a plurality of attribute values set in the search query.

The reference information in FIG. 3 indicates twenties, forties, and fifties as other attributes with a possibility of being confused with thirties.

Moreover, the reference information in FIG. 3 indicates thirties and fifties as other attributes with a possibility of being confused with forties.

In a case of the example, the modifying unit 12 includes, in a modified search query, twenties, forties, and fifties with a possibility of being confused with the thirties, all of thirties and fifties with a possibility of being confused with forties, and thirties and forties originally included in a search query.

There are various ways of setting a confidence level. For example, the modifying unit 12 may determine, as confidence levels of each attribute value set in a modified search query, a confidence level of each attribute value set in a search query, and a statistical value of a recent possibility of each attribute value indicated in reference information. The statistical value is an average value, a weighted average value, a maximum value, a minimum value, a mode value, a median value, or the like.

The reference information in FIG. 3 indicates 7% as a possibility of confusing thirties with fifties. Moreover, the reference information in FIG. 3 indicates 21% as a possibility of confusing forties with fifties. Thus, the modifying unit 12 sets statistical values of 7% and 21% as confidence levels of fifties in a modified search query. For a weight in a case where a weighted average value is adopted, a confidence level of each attribute value set in a search query can be adopted. In other words, a weight of 7% is a confidence level (20%) of thirties set in the search query. Then, a weight of 21% is a confidence level (70%) of forties set in the search query.

### Example 2

As another example, the modifying unit 12 may include, in a modified search query, another attribute value with a possibility of being confused with an attribute value with the highest confidence level among a plurality of attribute values of the same attribute set in a search query.

In the search query in the example described above, an attribute value with the highest confidence level is forties. In a case of the example, the modifying unit 12 includes, in a modified search query, thirties and fifties with a possibility of being confused with forties, and thirties and forties originally included in the search query. A way of setting a confidence level is similar to that in Example 1 described above.

### Example 3

As another example, the modifying unit 12 may include, in a modified search query, another attribute value with a possibility of being confused with all of a plurality of attribute values set in a search query.

In a search query in the example described above, another attribute value with a possibility of being confused with all of a plurality of attribute values that have been set is fifties. In a case of the example, the modifying unit 12 includes, in a modified search query, fifties, and thirties and forties originally included in a search query. A way of setting a confidence level is similar to that in Example 1 described above.

### “Second Modified Example”

An attribute to be targeted for modification by a modifying unit 12, and an attribute not to be targeted for modification by the modifying unit 12 may be previously defined. Then, the modifying unit 12 may target, for modification, only an attribute value of an attribute defined as a target of modification, and may not target, for modification, an attribute value of an attribute that is not defined as a target of modification.

For example, an attribute with a low possibility of being confused, such as a gender, can be excluded from a target for modification. Then, an attribute with a high possibility of being confused, such as an age, can be targeted for modification.

### “Third Modified Example”

A search unit 13 may execute both a search (hereinafter, “first search”) based on a search query (search query set by a user) accepted by an input accepting unit 11, and a search (hereinafter, “second search”) based on a modified search query generated by a modifying unit 12. Then, the search apparatus 10 may output a result of the first search and a result of the second search to the user, and output information inquiring of the user as to whether modification of the search query may be executed. Then, a search apparatus 10 may execute modification of the search query according to a user input indicating that modification of the search query may be executed.

In this case, the search query accepted by the input accepting unit 11 is displayed in a column of a search query on a search screen. Then, the result of the first search and the result of the second search are displayed on the search screen in a state where the search query is displayed in the column of the search query. Then, according to a user input indicating that modification of the search query may be executed, a content in the column of the search query is changed from the search query accepted by the input accepting unit 11 to a modified search query generated by the modifying unit 12.

Note that, in a case of outputting the result of the first search and the result of the second search to the user, a search apparatus 10 may output only a predetermined top number of both results to the user. Moreover, in a case of outputting the result of the first search and the result of the second search to the user, the search apparatus 10 may highlight a different part between both of the results.

The example embodiments according to the present invention have been described above with reference to the drawings, but are exemplifications of the present invention, and various configurations other than those described above can be adopted. The components according to the example components described above may be combined with each other, or some of the components may be replaced with other components. Moreover, various modifications may be made to the components according to the above-described example embodiments without departing from the scope thereof. Moreover, the components and processing disclosed in each of the above-described example embodiments and modified examples may be combined with each other.

Moreover, a plurality of processes (pieces of processing) are described in order in a plurality of flowcharts used in the above-described description. However, an execution order of processes executed in each example embodiment is not limited to the described order. In each example embodiment, an order of illustrated processes can be changed to an extent that causes no problem in terms of content. Moreover, each of the example embodiments described above can be combined to an extent that content does not contradict.

Some or all of the above-described example embodiments can also be described as, but are not limited to, the following supplementary notes.
1. A search apparatus including:
an input accepting unit that accepts a search query in which an attribute value and a confidence level of the attribute value are set for at least one attribute;
a modifying unit that modifies the set search query, based on the attribute value and the confidence level, and generates a modified search query; and
a search unit that searches, from among pieces of registered information registered in a database, for the registered information matching the modified search query.
2. The search apparatus according to supplementary note 1, wherein
the modifying unit
   generates the modified search query including a first attribute value of a first attribute and a second attribute value of the first attribute, in a case where the search query includes the first attribute value of the first attribute, and
the first attribute value and the second attribute value are different from each other.
3. The search apparatus according to supplementary note 2, wherein
the modifying unit
   generates the modified search query including, as the second attribute value, the attribute value indicated a possibility of being confused with the first attribute value in reference information indicating the another attribute value with a possibility of being confused with each of the attribute values.
4. The search apparatus according to supplementary note 3, wherein
the modifying unit
   determines the second attribute value to be included in the modified search query, based on the reference information indicating the another attribute value with a possibility of being confused with the attribute value in a case where the confidence level of the attribute value set in the search query satisfies a predetermined condition, and the confidence level of the first attribute value set in the search query.
5. The search apparatus according to supplementary note 3 or 4, wherein
the input accepting unit further accepts an input of setting an attribute of an eyewitness, and
the modifying unit
   determines the second attribute value to be included in the modified search query, based on the reference information indicating the another attribute value with a possibility of being confused with each of the attribute values in a case where an attribute of the eyewitness satisfies a predetermined condition, and the set attribute of the eyewitness.
6. The search apparatus according to any one of supplementary notes 3 to 5, wherein
the input accepting unit further accepts an input of setting an environment at witnessing, and
the modifying unit
   determines the second attribute value to be included in the modified search query, based on the reference information indicating the another attribute value with a possibility of being confused with each of the attribute values in a case where the environment at witnessing satisfies a predetermined condition, and the set environment at witnessing.
7. The search apparatus according to any one of supplementary notes 3 to 6, wherein
the modifying unit
   determines the second attribute value to be included in the modified search query, based on the reference information indicating the another attribute value with a possibility of being confused with each of the attribute values in a case where the another attribute value set in the search query satisfies a predetermined condition.
8. The search apparatus according to any one of supplementary notes 3 to 7, wherein
the reference information further indicates a possibility of confusing each of the attribute values with each of the other attribute values, and
the modifying unit determines the confidence level of the second attribute value in the modified search query, based on the possibility.
9. The search apparatus according to supplementary note 8, wherein
the reference information indicates a possibility of confusing each of the attribute values with each of the other attribute values for each of the confidence levels of the attribute value set in the search query, for each attribute of an eyewitness, for each environment at witnessing, or for each of the other attribute values set in the search query.
10. The search apparatus according to any one of supplementary notes 1 to 9, wherein
the modifying unit
   generates the modified search query, based on a plurality of the attribute values, in a case where the plurality of the attribute values are installed in association with the one attribute in the search query.
11. The search apparatus according to any one of supplementary notes 1 to 10, wherein
the modifying unit
   generates the modified search query from the search query, based on a learning model.
12. The search apparatus according to any one of supplementary notes 1 to 6, wherein
the modifying unit
   targets, for modification, the attribute value the confidence level of which is less than a criterion value.
13. A search method including,
by one or more computers:
   accepting a search query in which an attribute value and a confidence level of the attribute value are set for at least one attribute;
   modifying the set search query, based on the attribute value and the confidence level, and generating a modified search query; and
   searching, from among pieces of registered information registered in a database, for the registered information matching the modified search query.
14. A program causing a computer to function as:
an input accepting unit that accepts a search query in which an attribute value and a confidence level of the attribute value are set for at least one attribute;
a modifying unit that modifies the set search query, based on the attribute value and the confidence level, and generates a modified search query; and
a search unit that searches, from among pieces of registered information registered in a database, for the registered information matching the modified search query.

This application is based upon and claims the benefit of priority from Japanese patent application No. 2022-204368, filed on Dec. 21, 2022, the disclosure of which is incorporated herein in its entirety by reference.

### REFERENCE SIGNS LIST

10 Search apparatus
11 Input accepting unit
12 Modifying unit
13 Search unit
1A Processor
2A Memory
3A Input/output I/F
4A Peripheral circuit
5A Bus

What is claimed is:

1. A search apparatus comprising:
at least one memory configured to store one or more instructions; and
at least one processor configured to execute the one or more instructions to:
accept a search query in which an attribute value and a confidence level of the attribute value are set for at least one attribute;
modify the set search query, based on the attribute value and the confidence level;
generate a modified search query; and
search, from among pieces of registered information registered in a database, for the registered information matching the modified search query.

2. The search apparatus according to claim 1, wherein
the at least one processor is further configured to execute the one or more instructions to
generate the modified search query including a first attribute value of a first attribute and a second attribute value of the first attribute, in a case where the search query includes the first attribute value of the first attribute, and
the first attribute value and the second attribute value are different from each other.

3. The search apparatus according to claim 2, wherein
the at least one processor is further configured to execute the one or more instructions to
generate the modified search query including, as the second attribute value, the attribute value indicated a possibility of being confused with the first attribute value in reference information indicating the another attribute value with a possibility of being confused with each of the attribute values.

4. The search apparatus according to claim 3, wherein
the at least one processor is further configured to execute the one or more instructions to
determine the second attribute value to be included in the modified search query, based on the reference information indicating the another attribute value with a possibility of being confused with the attribute value in a case where the confidence level of the attribute value set in the search query satisfies a predetermined condition, and the confidence level of the first attribute value set in the search query.

5. The search apparatus according to claim 3, wherein the at least one processor is further configured to execute the one or more instructions to
accept an input of setting an attribute of an eyewitness, and
determine the second attribute value to be included in the modified search query, based on the reference information indicating the another attribute value with a possibility of being confused with each of the attribute values in a case where an attribute of the eyewitness satisfies a predetermined condition, and the set attribute of the eyewitness.

6. The search apparatus according to claim 3, wherein the at least one processor is further configured to execute the one or more instructions to
accept an input of setting an environment at witnessing, and
determine the second attribute value to be included in the modified search query, based on the reference information indicating the another attribute value with a possibility of being confused with each of the attribute values in a case where the environment at witnessing satisfies a predetermined condition, and the set environment at witnessing.

7. The search apparatus according to claim 3, wherein
the at least one processor is further configured to execute the one or more instructions to
determine the second attribute value to be included in the modified search query, based on the reference information indicating the another attribute value with a possibility of being confused with each of the attribute values in a case where the another attribute value set in the search query satisfies a predetermined condition.

8. The search apparatus according to claim 3, wherein
the reference information further indicates a possibility of confusing each of the attribute values with each of the other attribute values, and
the at least one processor is further configured to execute the one or more instructions to determine the confidence level of the second attribute value in the modified search query, based on the possibility.

9. The search apparatus according to claim 8, wherein
the reference information indicates a possibility of confusing each of the attribute values with each of the other attribute values for each of the confidence levels of the attribute value set in the search query, for each attribute of an eyewitness, for each environment at witnessing, or for each of the other attribute values set in the search query.

10. The search apparatus according to claim 1, wherein
the at least one processor is further configured to execute the one or more instructions to
generate the modified search query, based on a plurality of the attribute values, in a case where the plurality of the attribute values are set in association with the one attribute in the search query.

11. The search apparatus according to claim 1, wherein
the at least one processor is further configured to execute the one or more instructions to
generate the modified search query from the search query, based on a learning model.

12. The search apparatus according to any claim 1, wherein
the at least one processor is further configured to execute the one or more instructions to
target, for modification, the attribute value the whose confidence level is less than a criterion value.

13. A search method comprising,
by one or more computers:
accepting a search query in which an attribute value and a confidence level of the attribute value are set for at least one attribute;
modifying the set search query, based on the attribute value and the confidence level;
generating a modified search query; and
searching, from among pieces of registered information registered in a database, for the registered information matching the modified search query.

14. The search method according to claim 13, further comprising,
by the one or more computers,
generating the modified search query including a first attribute value of a first attribute and a second attribute value of the first attribute, in a case where the search query includes the first attribute value of the first attribute, wherein
the first attribute value and the second attribute value are different from each other.

15. The search method according to claim 14, further comprising,
by the one or more computers,
generating the modified search query including, as the second attribute value, the attribute value indicated a possibility of being confused with the first attribute value in reference information indicating the another attribute value with a possibility of being confused with each of the attribute values.

16. The search method according to claim 15, further comprising,
by the one or more computers,
determining the second attribute value to be included in the modified search query, based on the reference information indicating the another attribute value with a possibility of being confused with the attribute value in a case where the confidence level of the attribute value set in the search query satisfies a predetermined condition, and the confidence level of the first attribute value set in the search query.

17. A non-transitory computer-readable medium storing a program causing a computer to:
accept a search query in which an attribute value and a confidence level of the attribute value are set for at least one attribute;
modify the set search query, based on the attribute value and the confidence level;
generate a modified search query; and
search, from among pieces of registered information registered in a database, for the registered information matching the modified search query.

18. The non-transitory computer-readable medium according to claim 17, wherein
the program causes the computer to
generate the modified search query including a first attribute value of a first attribute and a second attribute value of the first attribute, in a case where the search query includes the first attribute value of the first attribute, and
the first attribute value and the second attribute value are different from each other.

19. The non-transitory computer-readable medium according to claim 18, wherein
the program causes the computer to
generate the modified search query including, as the second attribute value, the attribute value indicated a possibility of being confused with the first attribute value in reference information indicating the another attribute value with a possibility of being confused with each of the attribute values.

20. The non-transitory computer-readable medium according to claim 19, wherein
the program causes the computer to
determine the second attribute value to be included in the modified search query, based on the reference information indicating the another attribute value with a possibility of being confused with the attribute value in a case where the confidence level of the attribute value set in the search query satisfies a predetermined condition, and the confidence level of the first attribute value set in the search query.
